(19) United States
(12) Patent Application Publication
(10) Pub. No.: US 2014/0019842 A1
(43) Pub. Date: Jan. 16, 2014

(54) Dynamic Pivot Table Creation and Modification

(71) Applicants: James C. Montagna, Matthews, NC (US); Anthony K. Stone, Charlotte, NC (US); Carlos Esteban Ruiz Montoya, San Jose (CR)

(72) Inventors: James C. Montagna, Matthews, NC (US); Anthony K. Stone, Charlotte, NC (US); Carlos Esteban Ruiz Montoya, San Jose (CR)

(73) Assignee: Bank of America Corporation, Charlotte, NC (US)

(21) Appl. No.: 13/546,225

(22) Filed: Jul. 11, 2012

(51) Int. Cl. G06F 17/00

(52) U.S. Cl. 715/227

(57) ABSTRACT

In an exemplary embodiment, a method includes determining a plurality of field identifiers of a data set. A plurality of field cells that each correspond to a field identifier of the plurality of field identifiers are generated and displayed within an available fields region. A column field region and a row field region are displayed. A first field cell of the plurality of field cells is moved from the available fields region to the column field region or the row field region in response to a first input from a user. The pivot table is updated to include one or more rows or columns corresponding to the first field cell upon detection of the movement of the first field cell to the column field region or the row field region.

### TECHNICAL FIELD OF THE INVENTION

This invention relates generally to data analysis and, more specifically, to dynamic pivot table creation and modification.

### BACKGROUND OF THE INVENTION

A data set may include numerous data entries. Each entry of a data set may include a series of data values. In some situations, the data of a data set may be voluminous or stored in a complicated format and thus may be difficult to analyze. To facilitate analysis of data from a data set, various data values from the data set may be compiled and presented in a table format, such as a pivot table. A pivot table may facilitate quick and/or efficient analysis of various data recorded within the data set. A pivot table may also allow manipulation of the format in which the data of the data set is presented.

### SUMMARY OF THE INVENTION

In accordance with the teachings of the present disclosure, disadvantages and problems associated with generating pivot tables may be reduced or eliminated.

According to an exemplary embodiment, a method includes determining a plurality of field identifiers of a data set. The data set comprises a plurality of data entries that each comprise one or more data values that are each associated with a field identifier of the plurality of field identifiers. A plurality of field cells that each correspond to a field identifier of the plurality of field identifiers are generated and displayed within an available fields region. A column field region and a row field region are displayed. The column field region is operable to define one or more columns of a pivot table and the row field region is operable to define one or more rows of the pivot table. A first field cell of the plurality of field cells is moved from the available fields region to the column field region or the row field region in response to a first input from a user. The pivot table is updated to include one or more rows or columns corresponding to the first field cell upon detection of the movement of the first field cell to the column field region or the row field region.

Certain embodiments of the invention may provide one or more technical advantages. A technical advantage of one embodiment includes dynamically updating a pivot table in response to user input. Another technical advantage of one embodiment includes displaying field cells that define the structure of a pivot table in the same window as the pivot table. Another technical advantage of one embodiment includes dynamically updating a pivot table each time a field cell is moved to a new location. Another technical advantage of one embodiment includes providing an interface for intuitive creation and modification of a pivot table.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system that facilitates dynamic pivot table creation and modification;

FIG. 2 illustrates an example interface that facilitates dynamic pivot table creation and modification;

FIG. 3 illustrates an example method of facilitating dynamic pivot table creation and modification; and

FIG. 4 illustrates an example field properties list that facilitates dynamic pivot table creation and modification.

### DETAILED DESCRIPTION OF THE INVENTION

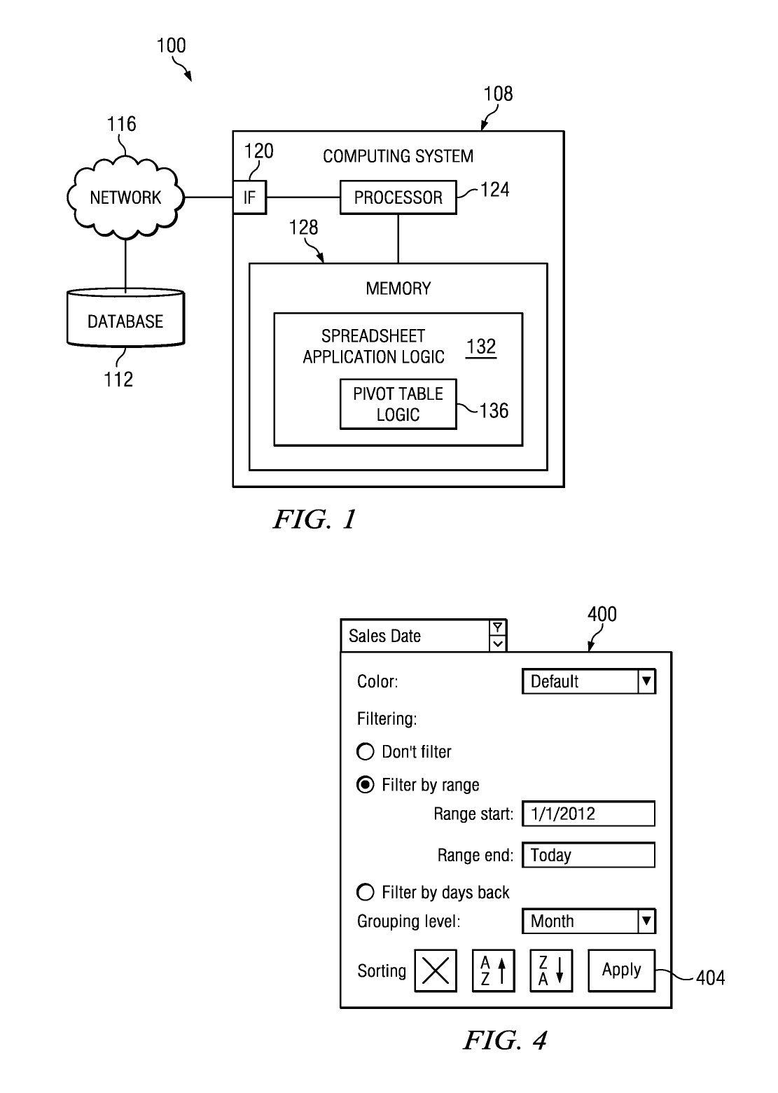

Embodiments of the present invention and its advantages are best understood by referring to FIGS. 1 through 4, like numerals being used for like and corresponding parts of the various drawings.

FIG. 1 illustrates an example system 100 that facilitates generation of a pivot table from a data set. System 100 includes one or more computing systems 108 and one or more databases 112 that communicate over one or more networks 116 to facilitate generation of a pivot table from a data set.

System 100 includes computing system 108, that communicates with database 112 through network 116 to generate pivot tables from data sets. Computing system 108 may include a personal computing system, a workstation, a laptop, a wireless or cellular telephone, an electronic notebook, a personal digital assistant, or any other device (wireless, wireline, or otherwise) capable of receiving, processing, storing, and/or communicating information with other components of system 100. Computing system 108 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. Computing system 108 may also comprise a user interface, such as a display, keyboard, mouse, or other appropriate terminal equipment.

System 100 further includes database 112 that communicates with computing system 108 through network 116. Database 112 stores, either permanently or temporarily, one or more data sets. Database 112 includes any one or a combination of volatile or non-volatile local or remote devices suitable for storing information. For example, database 112 may include random access memory (RAM), read-only memory (ROM), magnetic storage devices, optical storage devices, or any other suitable information storage device or combination of these devices.

Network 116 represents any suitable network operable to facilitate communication between the components of system 100, such as computing system 108 and database 112. Network 116 may include any interconnecting system capable of transmitting audio, video, signals, data, messages, or any combination of the preceding. Network 116 may include all or a portion of a public switched telephone network (PSTN), a public or private data network, a local area network (LAN), a metropolitan area network (MAN), a wide area network (WAN), a local, regional, or global communication or computing system network, such as the Internet, a wireline or wireless network, an enterprise intranet, or any other suitable communication link, including combinations thereof, operable to facilitate communication between the components.

In particular embodiments, system 100 may facilitate dynamic pivot table creation and modification. Computing system 108 may be operable to access one or more data sets stored by database 112, stored internally within computing system 108, or stored in a computer readable medium coupled to computing system 108, such as a flash drive or compact disk. Computing system 108 may receive information (e.g., through a user interface) that identifies a data set stored by database 112, computing system 108, or a computer readable medium coupled to computing system 108. Computing system 108 may communicate a request to access the identified data set. The data set may be accessed and a plurality of field identifiers of the data set may be determined. A field identifier is a description of one or more data values associated with the field identifier. As an example, a data set may include a field identifier “BALANCE” that is associated with various data values of the data set that each contain the amount of an account balance. As another example, the data set may include a field identifier “ACCOUNT NUMBER” that is associated with other data values of the data set that each contain an account number. A particular data entry of a data set may have a data value associated with the field identifier “BALANCE” and another data value associated with the field identifier “ACCOUNT NUMBER” such that the account balance may be linked to the particular account number.

Computing system 108 may generate a field cell for one or more of the field identifiers and display the field cells to a user. The user may move the field cells into various regions. Computing system 108 generates a pivot table by combining and/or filtering information from the data set based on the placement of one or more of the field cells. The pivot table may be generated or updated immediately after movement of each field cell. The pivot table may be displayed concurrently with the field cells in the same window. Particular embodiments of the present disclosure provide relatively quick and intuitive means for generating and modifying a pivot table. Particular embodiments allow the creation and modification of a pivot table on the fly without requiring a creation wizard that creates a pivot table after receiving all of the formatting information for the pivot table. Rather, particular embodiments of the present disclosure update the pivot table each time particular formatting information is received so that a user may analyze the effect that a particular action has on the pivot table.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computing system-readable medium or any other suitable tangible medium, and may perform operations when executed by a computing system. Certain logic, such as a processor, may manage the operation of a component. Examples of a processor include one or more computing systems, one or more microprocessors, one or more applications, and/or other logic.

As an example, computing system includes one or more network interfaces 120, one or more processors 124, and one or more memories 128, that collectively facilitate the generation of a pivot table from a data set.

Network interface 120 represents any suitable device operable to receive information from network 116, transmit information through network 116, perform processing of information, communicate with other devices, or any combination of the preceding. For example, network interface 120 may request data from database 112. As another example, network interface 120 may forward requests from computing system 108 and communicate the results of the requests to computing system 108. Network interface 120 represents any port or connection, real or virtual, including any suitable hardware and/or software, including protocol conversion and data processing capabilities, to communicate through a LAN, WAN, or other communication system that allows computing system 108 to exchange information with network 116, database 112, or other components of system 100.

Processor 124 communicatively couples to network interface 120 and memory 128 and controls the operation and administration of computing system 108 by processing information received from network interface 120 and memory 128. Processor 124 may be a programmable logic device, a microcontroller, a microprocessor, any suitable processing device, or any suitable combination of the preceding. Processor 124 includes any hardware and/or software that operates to control and process information. For example, processor 124 executes spreadsheet application logic 132 to control one or more operations of computing system 108.

Memory 128 stores, either permanently or temporarily, data, operational software, or other information for processor 124. Memory 128 includes any one or a combination of volatile or non-volatile local or remote devices suitable for storing information. For example, memory 128 may include RAM, ROM, magnetic storage devices, optical storage devices, or any other suitable information storage device or a combination of these devices. In the illustrated embodiment, memory 128 includes spreadsheet application logic 132 and pivot table logic 136. Spreadsheet application logic 132 and pivot table logic 136 each represent any suitable set of logic, rules, algorithms, code, tables, and/or other suitable instructions embodied in a computing system-readable storage medium for performing the described functions and operations of computing system 108. In the illustrated embodiment, pivot table logic 136 is embedded within spreadsheet application logic 132. In other embodiments, pivot table logic 136 may reside in memory 128 independent of spreadsheet application logic 132. In particular embodiments, spreadsheet application logic 132 and pivot table logic 136 may be operable to communicate with each other and/or may be able to execute one or more functions on behalf of the other. While illustrated as including a particular module, memory 128 may include any suitable information for use in the operation of computing system 108.

In some embodiments, one or more components of system 100 may be owned and/or operated by an enterprise. An enterprise may represent any individual, business, or organization. One example of an enterprise may include a financial institution. A financial institution may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

In operation, computing system 108 is operable to determine a plurality of field identifiers of a data set. The data set may comprise a plurality of data entries with each data entry comprising one or more data values. The data values may each be associated with a field identifier. Computing system 108 is operable to generate a plurality of field cells that each correspond to a field identifier of the plurality of field identifiers. Computing system 108 is operable to display the plurality of field cells within an available fields region and to display a column field region and a row field region. The column field region may be operable to define one or more columns of a pivot table and the row field region may be operable to define one or more rows of the pivot table. Computing system 108 is operable to move a first field cell of the plurality of field cells from the available fields region to the column field region or the row field region in response to a first input from a user. Computing system 108 is further operable to update the pivot table to include one or more rows or columns corresponding to the first field cell upon detection of the movement of the first field cell to the column field region or the row field region.

Modifications, additions, or omissions may be made to system 100 without departing from the scope of the invention. System 100 may include any number of computing systems 108, databases 112, networks 116, or other components. Any suitable logic may perform the functions of system 100 and the components within system 100.

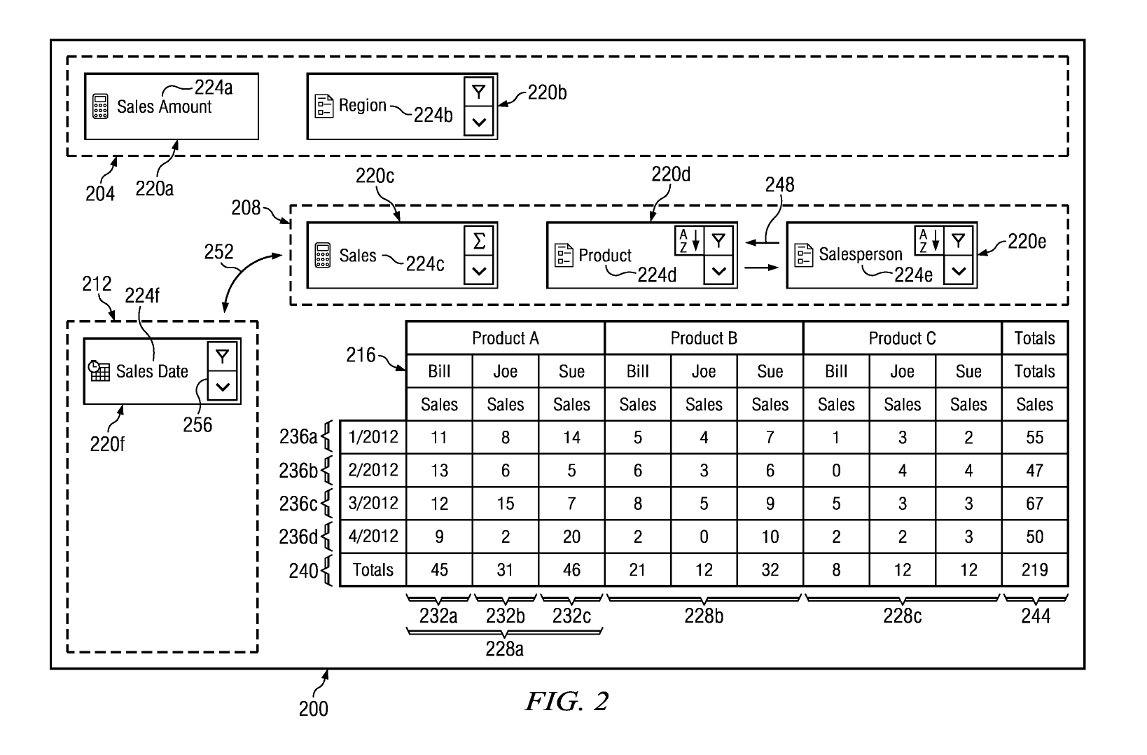

FIG. 2 illustrates an example interface 200 that facilitates dynamic pivot table creation and modification. In particular embodiments, interface 200 may be implemented by computing system 108 executing spreadsheet application logic 132 and/or pivot table logic 136. Interface 200 includes available fields region 204, column fields region 208, and row fields region 212. In the embodiment depicted, each of these regions includes one or more field cells 220. Each field cell 220 corresponds to a field identifier 224 of the data set that provides the data for pivot table 216. Pivot table 216 is structured according to the arrangement of the field cells 220 within column fields region 208 and row fields region 212. Interface 200 may represent a single window displayed by computing system 108. For example, interface 200 may be displayed on a single sheet of a spreadsheet. Accordingly, interface 200 is different from spreadsheet applications that provide a window for selecting the formatting properties of the pivot table prior to creation of the pivot table and another window for displaying the pivot table.

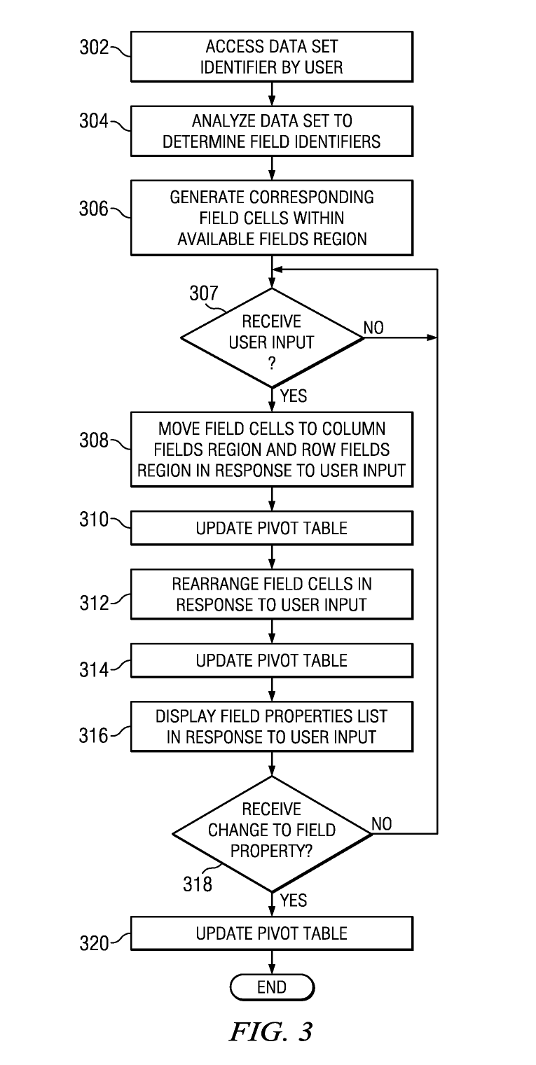

An example method for dynamic creation and modification of pivot table 216 is described in FIG. 3, which will be described in connection with the example interface 200 of FIG. 2. The method begins at step 302, where a data set identified by a user of computing system 108 is accessed. The identifying information may include a location and/or file name of the data set. The data set may be accessed from any suitable location. For example, the data set may be accessed from database 112, memory 128, or removable media coupled to computing system 108. The data set may be stored in any suitable manner. In some embodiments, the data set is compressed and stored according to a database format, such as a Standard Query Language (SQL), MICROSOFT ACCESS®, MICROSOFT EXCEL®, Hypertext Markup Language (HTML), text, or other database format. A data set may include a plurality of data entries. Each data entry may include a plurality of data values. Each data value of a data entry may be associated with a distinct field identifier. For example, a data value may indicate a value of the field identifier associated with the value. As an example, a data entry may include a data value “BILL” that is associated with a field identifier “SALESPERSON” and a data value “4” associated with a field identifier “SALES” that describes a number of units sold in a transaction represented by the data entry.

At step 304, the data set is analyzed and a list of field identifiers 224 of the data set is determined. The field identifiers 224 may be determined in any suitable manner. For example, pivot table logic 136 may include logic for extracting field identifiers 224 from any suitable database format. At step 306, field cells 220 that each correspond to a respective field identifier 224 are generated and displayed within available fields region 204. In particular embodiments, each field cell 220 is assigned a type that is based on the data values associated with the corresponding field identifier 224 in the data set. In particular embodiments, each displayed field cell 220 includes an icon indicative of the type of the field cell 220. Examples of types include numeric metric, time span metric, list, and date. A numeric metric field cell represents numeric data values that can be aggregated and displayed in pivot table 216. In the embodiment depicted, field cells 220a and 220c are numeric metric field cells. A time span metric field cell represents time quantity values that can be aggregated and displayed in pivot table 216. For example, the aggregated time quantity may be displayed as a number of days, hours, minutes, and/or seconds. A list field cell represents text values that allow filtering, grouping, and/or sorting of data displayed by pivot table 216. In the embodiment depicted, field cells 220b, 220d, and 220e are list field cells. A date field cell represents date values that allows filtering, grouping, and/or sorting of data displayed by pivot table 216. In the embodiment depicted, field cell 220f is a date field cell.

The field cells 220 placed in available fields region 204 may have any suitable order. For example, the metric field cells (i.e., numeric metric or time span metric field cells) may appear in a group at the left-most portion of the available fields region 204, the date field cells may appear to the right of the metric field cells, and the list field cells may appear to the right of the metric date field cells.

At step 307, it is determined whether user input has been received. Various types of user input are described in steps 308-320. In response to user input, computing system 108 may perform any one or more of steps 308-320, depending on the type of user input. Example types of user input and actions effectuated by computing system 108 in response to such user input is described with respect to steps 308-320.

At step 308, one or more field cells 220 are moved to column field region 208 or row field region 212 in response to user input. The user input may be any suitable input. For example, the user may drag and drop a field cell 220 from available fields region 204 to the drop region (i.e., column field region 208 or row field region 212). That is, a user may click on or touch the field cell 220 and drag the field cell 220 with a mouse or finger (or other input device) to the drop region and then release the click or the finger to effectuate the movement of the field cell 220. In a particular embodiment, a phantom copy of the field cell 220 is created at the beginning of the drag and drop operation and the phantom copy is dragged from the available fields region 204 to the drop region. The shadow copy then disappears and the field cell 220 disappears from the available fields region 204 and appears in the drop region. In a particular embodiment, a color, shape, or other display characteristic of the drop region changes (e.g., the region may be highlighted) when the field cell 220 is placed within or close to the drop region to notify the user that the click or finger may be released to complete the movement of the field cell 220 to the specified drop region. As another example, the field cell 220 may be moved by selecting or activating the field cell 220 and then providing any suitable indication of the desired drop region (e.g., by clicking the desired drop region). In yet another example, upon selection of the field cell 220, a menu may be displayed and the desired drop region may be selected from the menu. In particular embodiments, the column field region 208 may display an indication that notifies the user that field cells 220 placed within column field region 208 correspond to columns of pivot table 216. For example, column field region 208 may include text such as “DROP COLUMNS HERE.” Row field region 212 may display a similar indication.

Field cells 220 placed into the drop regions may have similar or different grouping and/or ordering to that described above with respect to the field cells 220 of available fields region 204 (with the top and bottom of row fields region 212 and the left and right of the column fields region 208 respectively corresponding to the left and right of the available fields region 204). In a particular embodiment, metric field cells are grouped together in column fields region 208 or row fields region 212 and non-metric field cells (i.e., date field cells and list field cells) are grouped together. In a particular embodiment, when a field cell 220 is placed into a drop region, it is placed at the end (e.g., right-most position or bottom-most position) of a group (e.g., the metric field group or the non-metric field group) of one or more field cells 220. In other embodiments, the field cell 220 may be placed at any suitable location with the drop region (e.g., to the right or left of a field cell 220 already present in the drop region).

In response to the movement of a field cell 220 to the column field region 208 or row field region 212, the pivot table 216 is updated at step 310. Pivot table 216 is initially displayed when a metric field cell 220c (either numeric metric or time span metric) is placed into the column field region 208 or row field region 212. Upon the placement of the first metric field cell 220 into a drop region, pivot table 216 is generated based on the locations of the metric field cell 220c and any other field cells 220 that are located within the column field region 208 and/or row field region 212 at the time the metric field cell 220c is placed into a drop region. Until a metric field cell 220c is placed into the column field region 208 or row field region 212, the space occupied by pivot table 216 remains blank. However, after pivot table 216 is initially displayed, an updated pivot table 216 is displayed immediately upon movement of a field cell 220 from the available fields region 204 into a drop region.

The structure of pivot table 216 is based on the location of the one or more field cells 220 placed into the column field region 208 and/or row field region 212. For example, pivot table 216 includes one or more columns 232 corresponding to each field cell 220 placed into the column fields region 208 and one or more rows 236 corresponding to each field cell 220 placed into the row fields region 212. In particular embodiments, the number of columns or rows of pivot table 216 may be based on the number of unique data values (in the specified data set) associated with the field identifiers 224 of the list or date field cells 220 placed into the drop regions, subject to filtering criteria described in further detail below. For example, with respect to field cell 224d, three column sets 228a-c are generated that are labeled with column titles “PRODUCT A,” “PRODUCT B,” and “PRODUCT C.” The column titles correspond to unique data values associated with the field identifier 224d (“PRODUCT”) in the data set. As another example, with respect to field cell 224f, four rows 236a-d are generated that are labeled with row titles “1/2012,” “2/2012,” “3/2012,” and “4/2012.” These row titles correspond to data values associated with the field identifier 224f (“SALES DATE”). In the case of the date field cell 220f, the row titles may each be an aggregation of various data values from the data set. For example, the title of row 236a (“1/2012”) may represent data entries that had data values of Jan. 3, 2012, Jan. 5, 2012, and Jan. 27, 2012 associated with the field identifier “SALES DATE.” The column titles and row titles may be referred to herein as field titles.

When multiple list or date field cells 220 are placed in the same drop region, the field cells 220 may form a hierarchy that is reflected in the structure of pivot table 216. For example, the left-most field cell 220d (excluding metric field cells) of the column fields region 208 may result in the generation of one or more corresponding column titles at the top level of pivot table 216 and each field cell 220 to the right of the left-most field cell may result in the generation of one or more corresponding column titles nested underneath each of the next highest level column titles. An example hierarchy is shown in FIG. 2. In the embodiment depicted, field cell 220d results in the generation of the top level column titles “PRODUCT A,” “PRODUCT B,” and “PRODUCT C.” Field cell 220e results in the generation of column titles “BILL,” “JOE,” and “SUE” nested underneath each of the top level column titles. A similar scheme may be used for the rows, with the top field cell 220 resulting in the generation of the left-most row titles, the field cell directly beneath the top-most field cell corresponding to row titles nested to the right of the left-most row titles, and so on.

The metric field cells placed in column fields region 208 each result in the generation of a column title and column placed beneath each column title of the lowest level. For example, in the embodiment depicted, there is only one metric field cell 220c in column fields region 208, so a column title “SALES” and corresponding column is placed beneath each instance of the lowest level column titles “BILL,” “JOE,” and “SUE.” If column fields region 208 included two metric field cells 220, two column titles and columns would be placed underneath each instance of the lowest level column titles “BILL,” “JOE,” and “SUE.” Each column title and column would correspond to one of the metric field cells 220. If the metric field cells were instead placed in the row fields region 212, the metric field cells would each result in the generation of a row title and row placed to the right of each row title of the lowest level of row titles.

In particular embodiments, color coding is used to show the relation between the field cells 220 and the field titles. When a field cell 220 is moved from the available fields region 204 to a drop region, the field cell 220 is automatically assigned a color that is different from any colors previously assigned to field cells located in the drop regions. The assignment of a color may involve changing the color of the field identifier 224 of the field cell 220 to the assigned color, coloring the perimeter of the field cell 220 with the assigned color, filling the field cell 220 with the assigned color, or other suitable marking of field cell 220 with the assigned color. The column titles or row titles corresponding to the particular field cell 220 will be assigned the same color. Thus, the text of the particular field title may be the assigned color, the box around the particular field title may be filled with the assigned color, or the field title may be marked with the assigned color in any other suitable manner. The color assigned to a particular field cell 220 may be manually changed by the user and this change may be persistent even when the field cell is moved between different drop regions.

In particular embodiments, interface 200 may include options to hide column or row titles (and the associated columns or rows) of pivot table 216 that do not have any data associated with the metric field cells 220 placed in the drop regions (or that aggregate to zero for each pivot table entry associated with the column or row title). For example, a user may configure a “HIDE/SHOW CELLS WITHOUT DATA” option and/or a “HIDE/SHOW CELLS WITH ZERO” option to effectuate hiding of the relevant entries of the pivot table 216. As an example, if no sales of Product A were recorded in the data set, the column set labeled Product A would not be displayed if the “HIDE/SHOW CELLS WITHOUT DATA” option is active. Alternatively, if this option is not active, all column or row titles may be displayed even if no data is associated with the associated entries. In such a case, a character such as a hyphen indicating that no data exists for the particular entry may be placed in the particular entry. Similarly, deactivation of the “HIDE/SHOW CELLS WITH ZERO” option may allow all column or row titles to be displayed even if each entry of the row or column aggregates to zero.

Interface 200 may also offer a “SHOW TOTALS FOR” option to display aggregated totals for the rows and/or columns. In the embodiment depicted, the rows and columns are totaled and the totals are displayed. The row totals are shown in totals column 244 while the column totals are shown in totals row 240. Any suitable aggregation method may be selected for the total value of a particular row or column. For example, sum, average, count (e.g., the number of times a particular value appears or the number of times any non-null value appears), minimum, maximum, range, mode, median, or other suitable aggregation function may be used. In particular embodiments, the table rows and/or columns may be sorted based on the aggregated totals. For example, the rows 236a-236d could be sorted by total sales in order to see the months in which the most sales were made.

At step 312, one or more field cells 220 are rearranged in response to user input. One or more field cells 220 may be moved to any suitable location and in any suitable manner. For example, one or more field cells 220 may be moved from a drop region to the other drop region or from a drop region back to the available fields region 204. The field cells 220 may be moved between regions in a manner similar to that described above in connection with moving a field cell 220 from the available fields region 204 to one of the drop regions. A field cell 220 located in a drop region may also be moved to a different position within that drop region. For example, field cell 220e may be selected and dragged (or otherwise moved) to the left of field cell 220d. In a particular embodiment, the positions of two field cells 220 are swapped by clicking or otherwise selecting a fields swap icon 248 shown as two opposing arrows. One or more fields swap icons 248 may be displayed between field cells 220 in the drop regions if the field cells may be swapped. For example, in a particular embodiment, metric field cells may be swapped with each other, list and date field cells may be swapped with each other, but a metric field cell may not be swapped with a list or date field cell. The field cells 220 may also be rearranged by clicking or otherwise selecting a swap axes icon 252. This results in movement of the field cells 220 of the column fields region 208 into the row fields region 212 and vice versa, thus transforming the columns into rows and vice versa. When the field cells 220 are moved between the regions during a swap axes operation, the existing hierarchy between field cells is maintained.

At step 314, pivot table 216 is updated in response to the rearrangement of the one or more field cells 220. The pivot table 316 may be updated and displayed upon detection of the rearrangement of a field cell 220 or the swapping of two field cells 220. Accordingly, a user is able to view the effect of a change to the structure of the pivot table 216 immediately after making the change.

At step 316, a field properties list is displayed in response to user input. Any suitable user input may result in the display of the field properties list. For example, the user may click or otherwise select a field properties icon 256 of a field cell 220. An example field properties list is described in further detail below in connection with FIG. 4. At step 318, it is determined whether a change to a field property has been received. If a change is not received (e.g., the user declines to make a change), the method moves back to step 307 to await further user input. If a change is made, the pivot table is updated at step 320 and the method ends.

Modifications, additions, or omissions may be made to method 300. The method may include more, fewer, or other steps. Additionally, steps may be performed in parallel or in any suitable order. Any suitable component of system 100 may perform one or more steps of method 300.

FIG. 4 illustrates an example field properties list 400. Field properties list 400 is an example of a list that may be shown for date field cell 220f. As explained below, field properties lists for other types of field cells 220 may include different properties.

Field properties list 400 includes options to change the color associated with field cell 220f. For example, as explained above, field cell 220f may have had a color automatically assigned to it when it was placed in row fields region 212. This color may be manually changed through field properties list 400. Field properties list 400 also includes various filtering options. For example, filtering may be turned off by selecting “DON'T FILTER.” In the embodiment depicted, the “FILTER BY RANGE” option is selected and “RANGE START” and “RANGE END” dates are specified. As another example, the filtering range may be the current date back to a specified number of days previous to the current date by using the “FILTER BY DAYS BACK” option. The filtering options determine which data entries of the data set will be represented in pivot table 216. For example, under the selected filtering scheme, only data entries that have data values between Jan. 1, 2012 and the current date for the “SALES DATE” field identifier in the data set will be included in the results shown by pivot table 216. Accordingly, the filtering options may limit the amount of row titles (and rows) that are displayed in pivot table 216. When a date value is needed for the filtering options, a date input control may allow manual input of a date value or a selection of a date from a calendar. In particular embodiments, icons to select the oldest, latest, and/or current date values are provided. A “GROUPING LEVEL” such as a day, month, or year may also be specified. The grouping level determines the granularity of the row (or column) titles. Because “MONTH” is selected in the embodiment depicted, the row titles are shown in monthly increments. Various sorting options, such as none, ascending, descending, increasing, or decreasing are also available to specify the ordering of the row titles of rows 236. If a metric field cell 220 is in one of the drop regions and has a sort option enabled (as described in further detail below), the sorting option of the date field cell 220f will be ignored, but will be stored and become effective upon removal of the sort option for the metric field cell.

In particular embodiments, different field property options are shown based on whether field cell 220f is located within available fields region 204 or within one of the drop regions. For example, if field cell 220f is located within available fields region 204, the filtering options may be the only options that are available, since the other options are irrelevant until field cell 220f is placed into one of the drop regions to define the structure of pivot table 216.

Field properties list 400 also includes a button 404 for applying any changes made to field properties list 400. Upon clicking or otherwise selecting button 404, the field properties list 400 disappears and pivot table 216 is updated in accordance with the one or more changes to the field properties at step 320. In other embodiments, pivot table 216 is updated each time a field property is changed without waiting for a user to select button 404 to apply the changes.

As described above, different types of field cells may include different field properties lists. Similar to a date field cell 220f, a list field cell 220d may include options for specifying the color settings, the filter settings, and the sort settings. When the list field cell 220d is located in the available fields region 204, only the filter settings are available. The color settings and the sort settings that are also available when the list field cell 220d is located in a drop region may operate in a similar manner to the color settings and the sort settings of the date field cell 220f as described above. The filter settings may include a list of all available field titles (i.e., the unique data values in the data set that are associated with the field identifier 224d of the list field cell 220d). One or more of these field titles may be selected and the selected field titles are filtered out of the pivot table 216 results. Changes to the properties of list field cell 220d may result in immediate updating of pivot table 216 (upon the change) or the pivot table may be updated after a user confirms the change (e.g., by pressing an “APPLY” button).

Similar to the date field cell 220f and list field cell 220d, a metric field cell 220c may include options for specifying the color settings and the sort settings. The color settings and the sort settings may operate in a similar manner to the color settings and the sort settings of the date field cell 220f as described above. For example, the sort settings may allow pivot table 216 to be sorted according to the metric values of the entries of the pivot table 216 (accordingly the ordering of the row titles and/or column titles may be dependant on this sorting, although if multiple field cells are in a drop region the hierarchy of the titles of the pivot table would remain the same with only the lower level titles of the hierarchy sorted according to the metric). In a particular embodiment, none of the settings of the metric field cell 220c are available unless the metric field cell 220c is placed in a drop region.

Metric field cell 220c may also include an aggregation setting. The aggregation setting defines the aggregation function to use for the metrics associated with the metric field cell 220c that are used to populate the entries of pivot table 216. Any suitable aggregation function (or no aggregation function) may be used such as sum, average, count (e.g., the number of times a particular value appears or the number of relevant data entries that include any value), minimum, maximum, range, mode, median, or other suitable function. For a particular entry of pivot table 216, the aggregation function will be applied to each data entry from the data set that meets the filtering criteria defined by the properties specified for the particular entry of the pivot table 216. For example, in the embodiment depicted, metric field cell 220c has an aggregation setting equal to sum, as shown by the summation icon of metric field cell 220c. Thus, the entry “11” shown at the upper left hand corner of the pivot table is the result of summing the data values associated with the field identifier “SALES” for the data entries that also have data values of “BILL” and “PRODUCT A” respectively associated with the field identifiers “SALESPERSON” and “PRODUCT” and that have a data value specifying a date in January, 2012 that is associated with the field identifier “SALES DATE.”

Changes to the properties of metric field cell 220c may result in immediate updating of pivot table 216 (upon the change) or the pivot table may be updated after a user confirms the change (e.g., by pressing an “APPLY” button).

Interface 200 may also include various global options. Examples discussed already include the “HIDE/SHOW CELLS WITHOUT DATA,” “HIDE/SHOW CELLS WITH ZERO,” and the “SHOW TOTALS FOR” options. Another example is a “RESET TO SYSTEM DEFAULT VIEW” option that reverts back to a predefined pivot table structure (for example the predefined pivot table structure may be associated with a particular file or configuration). As another example, a “RESET TO EMPTY VIEW” option may remove all field cells 220 back to the available fields region 204 and clear all filters and sorting options. A “CLEAR ALL DROP ZONES” option may remove all field cells 220 back to the available fields region 204 but preserve field cell properties, such as aggregation, filters, and sorting options. A “CLEAR ALL FILTER OPTIONS” option clears the filtering options for every field cell 220. A “CLEAR ALL SORT OPTIONS” option clears the sort options for every field cell 220.

Certain embodiments of the invention may provide one or more technical advantages. A technical advantage of one embodiment includes dynamically updating a pivot table in response to user input. Another technical advantage of one embodiment includes displaying field cells that define the structure of a pivot table in the same window as the pivot table. Another technical advantage of one embodiment includes dynamically updating a pivot table each time a field cell is moved to a new location. Another technical advantage of one embodiment includes providing an interface for intuitive creation and modification of a pivot table. Certain embodiments of the present disclosure may include some, all, or none of the above advantages. One or more other technical advantages may be readily apparent to those skilled in the art from the figures, descriptions, and claims included herein.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising:
a processor operable to:
determine a plurality of field identifiers of a data set, the data set comprising a plurality of data entries, a data entry comprising one or more data values, a data value associated with a field identifier of the plurality of field identifiers;
generate a plurality of field cells that each correspond to a field identifier of the plurality of field identifiers;
display the plurality of field cells within an available fields region; and
display a column field region and a row field region, the column field region operable to define one or more columns of a pivot table, the row field region operable to define one or more rows of the pivot table; and
an interface operable to accept a first input from a user; and
wherein the processor is further operable to:
move a first field cell of the plurality of field cells from the available fields region to the column field region or the row field region in response to the first input from a user; and
update the pivot table to include one or more rows or columns corresponding to the first field cell upon detection of the movement of the first field cell to the column field region or the row field region.

2. The apparatus of claim 1, wherein the first input from the user comprises a dragging of the first field cell of the plurality of field cells from the available fields region to the column field region or the row field region.

3. The apparatus of claim 1, wherein the pivot table includes a plurality of column titles arranged in a hierarchy according to an order of a plurality of field cells placed in the column field region, a column title providing a label for one or more columns of the pivot table.

4. The apparatus of claim 1, wherein the first field cell is moved to the column field region and the processor is further operable to update a hierarchy of at least two column titles of the pivot table in response to a rearrangement of the first field cell and a second field cell within the column field region, a column title providing a label for one or more columns of the pivot table.

5. The apparatus of claim 1, wherein the processor is further operable to apply a color to the first field cell and to one or more corresponding field titles of the pivot table in response to the first field cell being moved from the available fields region to the column field region or the row field region.

6. The apparatus of claim 1, wherein the processor is further operable to:
display a field properties list comprising one or more field properties of the first field cell in response to a selection of an icon associated with the first field cell; and
update the pivot table in response to an adjustment of a field property of the field properties list.

7. The apparatus of claim 1, wherein the available fields region, the column region, and the row region are displayed in a common window.

8. A non-transitory computing system readable medium comprising logic, the logic, when executed by a processor, operable to:
determine a plurality of field identifiers of a data set, the data set comprising a plurality of data entries, a data entry comprising one or more data values, a data value associated with a field identifier of the plurality of field identifiers;
generate a plurality of field cells that each correspond to a field identifier of the plurality of field identifiers;
display the plurality of field cells within an available fields region;
display a column field region and a row field region, the column field region operable to define one or more columns of a pivot table, the row field region operable to define one or more rows of the pivot table;
move a first field cell of the plurality of field cells from the available fields region to the column field region or the row field region in response to a first input from a user; and
update the pivot table to include one or more rows or columns corresponding to the first field cell upon detection of the movement of the first field cell to the column field region or the row field region.

9. The computing system readable medium of claim 8, wherein the first input from the user comprises a dragging of the first field cell of the plurality of field cells from the available fields region to the column field region or the row field region.

10. The computing system readable medium of claim 8, wherein the pivot table includes a plurality of column titles arranged in a hierarchy according to an order of a plurality of field cells placed in the column field region, a column title providing a label for one or more columns of the pivot table.

11. The computing system readable medium of claim 8, wherein the first field cell is moved to the column field region and the logic is further operable to update a hierarchy of at least two column titles of the pivot table in response to a rearrangement of the first field cell and a second field cell within the column field region, a column title providing a label for one or more columns of the pivot table.

12. The computing system readable medium of claim 8, wherein the logic is further operable to apply a color to the first field cell and to one or more corresponding field titles of the pivot table in response to the first field cell being moved from the available fields region to the column field region or the row field region.

13. The computing system readable medium of claim 8, wherein the logic is further operable to:
display a field properties list comprising one or more field properties of the first field cell in response to a selection of an icon associated with the first field cell; and
update the pivot table in response to an adjustment of a field property of the field properties list.

14. The computing system readable medium of claim 8, wherein the available fields region, the column region, and the row region are displayed in a common window.

15. A method, comprising:
determining a plurality of field identifiers of a data set, the data set comprising a plurality of data entries, a data entry comprising one or more data values, a data value associated with a field identifier of the plurality of field identifiers;
generating, by a processor, a plurality of field cells that each correspond to a field identifier of the plurality of field identifiers;
displaying the plurality of field cells within an available fields region;
displaying a column field region and a row field region, the column field region operable to define one or more columns of a pivot table, the row field region operable to define one or more rows of the pivot table;
moving a first field cell of the plurality of field cells from the available fields region to the column field region or the row field region in response to a first input from a user; and
updating, by the processor, the pivot table to include one or more rows or columns corresponding to the first field cell upon detection of the movement of the first field cell to the column field region or the row field region.

16. The method of claim 15, wherein the first input from the user comprises a dragging of the first field cell of the plurality of field cells from the available fields region to the column field region or the row field region.

17. The method of claim 15, wherein the pivot table includes a plurality of column titles arranged in a hierarchy according to an order of a plurality of field cells placed in the column field region, a column title providing a label for one or more columns of the pivot table.

18. The method of claim 15, wherein the first field cell is moved to the column field region and the method further comprises updating a hierarchy of at least two column titles of the pivot table in response to a rearrangement of the first field cell and a second field cell within the column field region, a column title providing a label for one or more columns of the pivot table.

19. The method of claim 15, further comprising applying a color to the first field cell and to one or more corresponding field titles of the pivot table in response to the first field cell being moved from the available fields region to the column field region or the row field region.

20. The method of claim 15, further comprising:
displaying a field properties list comprising one or more field properties of the first field cell in response to a selection of an icon associated with the first field cell; and
updating the pivot table in response to an adjustment of a field property of the field properties list.

21. The method of claim 15, wherein the available fields region, the column region, and the row region are displayed in a common window.
